(19) United States
(12) Patent Application Publication
(10) Pub. No.: US 2025/0016748 A1
(43) Pub. Date: Jan. 9, 2025

(54) METHOD AND SYSTEM FOR INTEGRATED SENSING AND COMMUNICATION

(71) Applicant: Samsung Electronics Co., Ltd., Gyeonggi-do (KR)

(72) Inventors: Liang HU, San Diego, CA (US); Philippe Jean Marc Michel SARTORI, Naperville, IL (US); Jung Hyun BAE, San Diego, CA (US)

(21) Appl. No.: 18/763,883

(22) Filed: Jul. 3, 2024

Related U.S. Application Data
(60) Provisional application No. 63/511,716, filed on Jul. 3, 2023.

(51) Int. Cl. H04W 72/0446; H04W 72/0453; H04W 72/1268; H04W 72/231; H04W 72/25; H04W 74/0833

(52) U.S. Cl. CPC H04W 72/0446; H04W 72/0453; H04W 72/1268; H04W 72/231; H04W 72/25; H04W 74/0833

(57) ABSTRACT

Methods and devices of a wireless system are provided. A user equipment (UE) receives a first configuration defining a first set of time domain resources for radar sensing. The first configuration includes at least one of a frame structure comprising radar sensing slots or a slot structure comprising radar sensing symbols. The UE performs radar sensing within the first set of time domain resources and first frequency domain resources. The first set of time domain resources at least partially overlap time domain resources for communication based on one or more different beams, spatial filters, or spatial angles. The first frequency domain resources at least partially overlap second frequency domain resources for communication based on one or more different beams, spatial filters, or spatial angles.

### CROSS-REFERENCE TO RELATED APPLICATION

This application claims the priority benefit under 35 U.S.C. § 119(e) of U.S. Provisional Application No. 63/511,716, filed on Jul. 3, 2023, the disclosure of which is incorporated by reference in its entirety as if fully set forth herein.

### TECHNICAL FIELD

The disclosure generally relates to wireless systems. More particularly, the subject matter disclosed herein relates to improvements to integrated sensing and communication (ISAC) in wireless systems.

### SUMMARY

In a wireless system with ISAC, which may also be referred to as joint sensing and communication (JSAC), sensing and communication may share the same frequency band and hardware. As wireless technologies, such as massive multiple input-multiple output (MIMO), evolve with more antenna elements and a wider bandwidth in higher frequency bands (e.g., millimeter-wave (mm-wave) bands), they become more reliant on increasingly specific and accurate assistance information (e.g., distance (range), angle, instantaneous velocity, and area of objects).

To solve this problem, wireless sensing technologies aim to acquire information about a remote object without physical contact. The sensing data of the object and its surroundings may then be utilized for analysis so that meaningful information about the object and its characteristics may be obtained with high resolution and reliable accuracy.

Leveraging the strengths of wireless sensing technologies may be advantageous for the development of future wireless communication technologies. Accordingly, the integration of sensing and communication in 5^{th} generation (5G)-Advanced and 6^{th} generation (6G) wireless systems is expected to be beneficial.

One issue with the above approach is that current wireless systems are designed without taking into account the possibility of sensing. To provide sensing capability, several enhancements may be required with respect to system design. In particular, there may be slots in which a user equipment (UE) performs transmission for sensing, but does not perform transmission of information. Thus, for integrated sensing, a slot structure may be required in addition to a resource allocation in time, frequency, and spatial domain.

To overcome these issues, a UE may be configured with various time/frequency/spatial resource allocation methods for communication and sensing. A UE signaling procedure may also be provided to request a 5G/6G base station (or gNode B (gNB)) to activate or release resources for sensing.

In an embodiment, a method is provided in which a UE receives a first configuration defining a first set of time domain resources for radar sensing. The first configuration includes at least one of a frame structure comprising radar sensing slots or a slot structure comprising radar sensing symbols. The UE performs radar sensing within the first set of time domain resources and first frequency domain resources. The first set of time domain resources at least partially overlap time domain resources for communication based on one or more different beams, spatial filters, or spatial angles. The first frequency domain resources at least partially overlap second frequency domain resources for communication based on one or more different beams, spatial filters, or spatial angles.

In an embodiment, a method is provided in which a UE receives a first set of sensing activity states and a second set of radar sensing type categories. The UE receives corresponding radar sensing resources for different combinations of sensing activity states from the first set and radar sensing type categories from the second set. The UE transmits an indication of a radar sensing activity state from the first set and a radar sensing type category from the second set. The UE receives an activation indication for radar sensing resources associated with the radar sensing activity state and the radar sensing type category.

In an embodiment, a UE is provided that includes a processor and a non-transitory computer readable storage medium storing instructions. When executed, the instructions cause the processor to receive a first configuration defining a first set of time domain resources for radar sensing. The first configuration comprises at least one of a frame structure comprising radar sensing slots or a slot structure comprising radar sensing symbols. The instructions also cause the processor to perform radar sensing within the first set of time domain resources and first frequency domain resources. The first set of time domain resources at least partially overlap time domain resources for communication based on one or more different beams, spatial filters, or spatial angles. The first frequency domain resources at least partially overlap second frequency domain resources for communication based on one or more different beams, spatial filters, or spatial angles.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating sensing modes of a wireless communication system;

FIG. 2 is a diagram illustrating an orthogonal frequency division multiplexing (OFDM)-based sensing frame;

FIG. 3 is a diagram illustrating the coexistence of a sensing signal and a communication signal in a mono-static sensing case, according to an embodiment;

FIG. 4 is a diagram illustrating a slot structure with a combined pattern, according to an embodiment;

FIG. 5 is a diagram illustrating a time pattern demonstrating the integration of joint communication and sensing, according to an embodiment;

FIG. 6 is a flowchart illustrating a configuration process of a time pattern with allocated resources for communication and sensing, according to an embodiment;

FIG. 7 is a flowchart illustrating a method for performing sensing on uplink slots under certain conditions, according to an embodiment;

FIG. 8 is a flowchart illustrating a method for requesting and configuring radar sensing resources/sequences, according to an embodiment; and

FIG. 9 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Wide bandwidths and large antenna arrays may be considered symbols of high-resolution radar systems and modern communication systems. Applicable frequencies have increased in successive generations of communication systems and many key radar bands for high resolution sensing are merging with communication bands. For example, popular radar bands including K (18 gigahertz (GHz)-26.5 GHz) and Ka (26.5 GHz-40 GHz) are close to popular mmWave communication bands. Furthermore, the bandwidth of modern communication systems is fairly large, thereby creating opportunities for ISAC.

Radar technology and wireless telecommunications have coexisted for some time, but efforts have generally concentrated on interference management that enables the two technologies to operate as smoothly as possible without disturbing one another. These efforts have increased infrastructure costs and resulted in spectrum usage inefficiencies.

ISAC refers to the introduction of sensing capability to wireless communication networks. An objective of ISAC is to share the spectrum more efficiently and reuse the existing wireless network infrastructure for sensing. Sensing may refer to “radar-like” functionality (i.e., the ability to detect the presence, movement, and other characteristics of objects under the coverage of the wireless network). However, sensing may also refer to other types of sensing, such as, for example, detection of general characteristics of the environment, local weather conditions, etc.

Compared to the deployment of a separate network providing a sensing functionality, ISAC is beneficial in that the sensing capability may be introduced on large scale at a relatively low incremental cost by piggybacking on infra-structure that is already deployed for communication purposes. A massive communication infrastructure already exists, and an even more dense deployment may be available in future generations of wireless communication, which would allow for enhanced sensing capabilities. Accordingly, it may be possible to enable mono-static radar applications, in which the transmission of a radar signal and the reception of a reflected signal are handled by the same node, as well as various multi-static setups, in which transmission and reception are handled by different collaborating nodes.

If implemented properly, the integration of sensing into a communication network provides for better spectrum utilization when compared to assigning separate spectrum chunks for the two applications.

ISAC has begun to emerge as part of standardization efforts. For example, one such standard aims to use sensing to benefit end user applications (e.g., home security, entertainment, energy management home elderly care, and assisted living). There has also been an increased effort to introduce ISAC in a beyond 5G standard for applications such as traffic monitoring and safety, presence detection, localization and mapping, etc.

Sensing and communication traditionally address completely different sets of use cases and requirements. In its simplest form, sensing uses a known signal that is sent in a particular direction. By analyzing a reflected signal, various parameters such as channel response, target-presence, and target properties (e.g., position, shape, size, velocity, etc.) may be estimated. In contrast, communication key performance indicators include data-rate, latency and reliability. This leads to sensing signal characteristics (e.g., bandwidth, time duration, periodicity, power, etc.) to be different than those used for communication purposes.

There are multiple market segments and verticals in which 5G-Advanced-based sensing services may be beneficial for intelligent transportation, aviation, enterprise, smart city, smart home, smart factories, consumer applications, and public sector. A sensing wireless system, that relies on the same 5G new radio (NR) wireless communication system and infrastructure, offers sensing information that may be utilized to assist wireless communication functionalities, such as, for example, radio resource management, interference mitigation, beam management, mobility, etc. Sensing services and sensing-assisted communications may be more efficient when wireless sensing and communication are integrated in the same wireless channel or environment.

Four use cases that may benefit from ISAC include the perception of blind spots in road traffic areas, the perception of road dynamic information, contactless respiration monitoring, and gesture recognition.

With respect to the perception of blind spots in road traffic areas, a blind spot of a car refers to an area where a driver's line of sight is blocked by obstacles or the car itself and cannot be directly observed by the driver. Sub-use cases may relate to heavy vehicles having large blind spots that cause the most traffic accidents.

With respect to the perception of road dynamic information, this use case may be classified into traffic jam detection and traffic safety risk detection. Severe traffic congestion directly reduces travel efficiency, impacts people's lives, and limits manufactory production, while indirectly increasing air pollution and affecting people's health. Dangerous driving behaviors may be induced by speeding, sharp turns, sudden acceleration, and sudden braking. Current detection that focuses on the acquisition of road dynamic information generally relates to cameras and speed-measuring radars having a limited deployment scope.

With respect to contactless respiration monitoring, respiratory diseases suffered by people worldwide incur a large global health burden, particularly for vulnerable infants and young children. A human's sleep situation may be monitored with 3GPP-based wireless signals.

With respect to gesture recognition, there is flexibility in expressing meanings from portions of the human body, such as a head, a hand, a leg, and a combination of human body parts. Two types of schemes for gesture recognition include device-based and device-free, which correspond to wearable devices and non-wearable devices, respectively. Common sensors for device-based solutions include a camera, a depth camera, a glove, and a wristband, while sensors for device-free solution include radar.

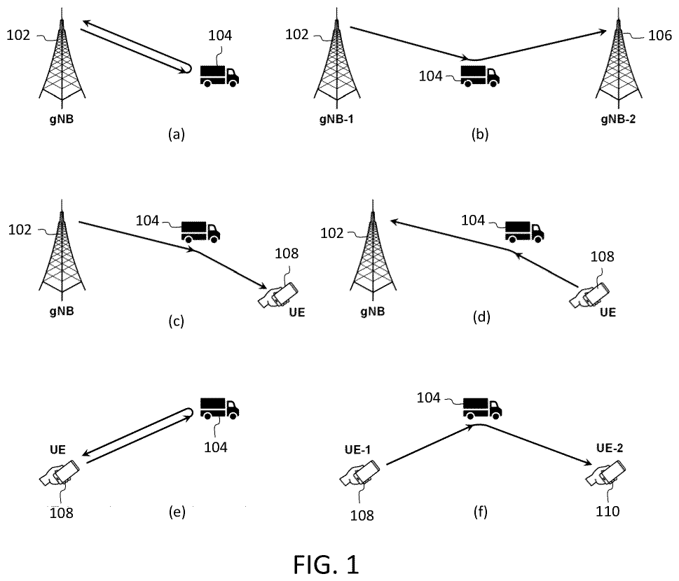

FIG. 1 is a diagram illustrating six sensing modes. A first mode (a) is gNB-based mono-static sensing in which a sensing signal is transmitted from a first gNB 102 and a signal reflected from an object 104 is received by the first gNB 102. A second mode (b) is gNB1-to-gNB2 based bi-static sensing in which a sensing signal is transmitted from the first gNB 102 and a signal reflected from the object 104 is received by a second gNB 106. A third mode (c) is gNB-to-UE-based bi-static sensing in which a sensing signal is transmitted from the first gNB 102 and a signal reflected from the object 104 is received by a first UE 108. A fourth mode (d) is UE-to-gNB-based bi-static sensing in which a sensing signal is transmitted from the first UE 108 and a reflected signal from the object 104 is received by the first gNB 102. A fifth mode (e) is UE-based mono-static sensing in which a sensing signal is transmitted from the first UE 108 and a reflected signal from the object 104 is received by the first UE 108. A sixth mode (f) is UE1-to-UE2-based bi-static sensing in which a sensing signal is transmitted from the first UE 108 and a reflected signal from the object 104 is received by a second UE 110. Several sensing modes may also be used together.

In a typical radar-like scenario, there are requirements for certain parameters. These parameters include range resolution (Rr), which is a minimum distance between two objects that is distinguishable by a radar, unambiguous range (Ru), which is a maximum range that an object can be unambiguously detected, velocity resolution (vr), which is a minimum change in speed that can be measured by the radar, and unambiguous velocity (vu), which is a maximum range of speed (vmax−vmin) that can be measured by the radar. Based on these parameters, there are requirements on the duration, bandwidth, and periodicity of the sensing signal.

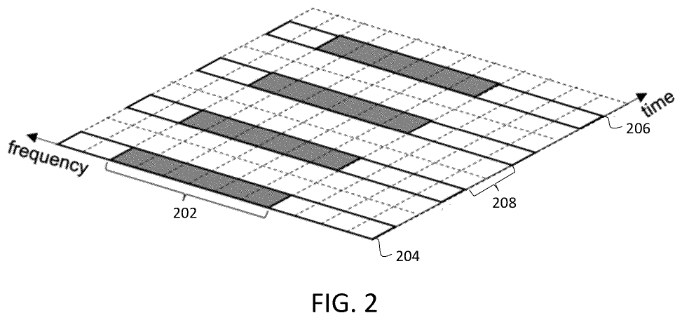

FIG. 2 is a diagram illustrating an OFDM-based sensing frame. A bandwidth (BW) 202 of a sensing signal is shown along a frequency at a given time. The sensing frame begins at an initial time Tᵢₙₜ 204 and ends at a final time T_{f} 206 of the sensing frame duration, with a gap Tᵣ 208 between sensing signals in the sensing frame.

Table 1 shows the relationship between sensing signal parameters and sensing requirements.

TABLE 1

| | |
|---|---|
| Minimum bandwidth | BWₘᵢₙ = c/2Rᵣ |
| Minimum gap between sensing signals | T_{r min} = 2Rᵤ/c |
| Maximum gap between sensing signals | T_{r max} = c/4f_{c}vᵤ |
| Minimum sensing frame duration | T_{f min} = c/2f_{c}vᵣ |

According to an embodiment, resource allocation may be provided for joint scheduling, integrating sensing operations into a frame structure with a defined time pattern that includes uplink (U), downlink (D), flexible (F), and radar (R) components expressed in terms of symbols/slots/subframes/frames. This allocation may be indicated by higher layers including, for example, system information block (SIB), radio resource control (RRC), or layer-1 (L1)/layer-2 (L2) signaling (e.g., a medium access control-control element (MAC-CE) or downlink control information (DCI)). The allocation may utilize existing time division duplexing (TDD) downlink (DL)/uplink (UL) time patterns. The time patterns may include “reserved” symbols/slots for sensing and may employ different numerologies for communication and sensing. Wide frequency allocation may be employed for highly precise sensing purposes, with the frequency configuration indicated in absolute units (e.g., gigahertz (GHz)) or relative to the communication frequency grid (e.g., resource block (RB) index, subcarrier index, resource block group (RBG), etc.). Sensing frequency resources may fully/partially/not overlap with communication frequency resources, encompassing resources within or outside serving cells/active bandwidth part(s) (BWP(s))/dormant BWP(s). Wide-band sensing may span multiple bands through carrier aggregation, and may utilize non-orthogonal frequency division multiplexing (OFDM) waveforms for communication and/or sensing.

A UE may be configured with diverse methods for allocating time and frequency resources for communication and sensing. For example, separate resources may be allocated for radar sensing and communication. Non-overlapping or fully orthogonal allocation may be used between radar sensing and communications, such as, for example, time division multiplexing (TDM) or frequency division multiplexing (FDM) in the time or frequency domain. Alternatively, resources may partially or fully overlap in one domain (i.e., frequency or time domain) while being separate in the other domain. This separation or overlap may apply to sensing transmission, sensing reception, or both. The term “overlap”, as used herein refers to a situation where resources overlap in one domain but not the other. For example, resources may overlap in the frequency domain and not the time domain, or resources may overlap in the time domain and not the frequency domain.

A UE may have a time pattern configuration where a specific set of symbols/slots/subframes/frames is designated for radar sensing, while another set is dedicated to communication. These sets do not overlap. For example, radar resources may be denoted as “R” (radar sensing), while communication resources may be referred to as “C” (communication), “D” (downlink), “U” (uplink), or “SL” (sidelink).

A time pattern, also referred to as a slot format or communication-radar time pattern, may have various structures. A time pattern may include a certain number of slots for radar sensing followed by a specific number of slots for communication. Alternatively, a time pattern may involve a combination of slots and symbols for radar sensing, followed by slots and symbols for communication. Guard symbols or slots may be inserted between radar and communication resources to allow for a switching time between the radar sensing and communication modules.

For mono-static or bi-static sensing and the coexistence of a sensing signal and a communication signal in the same frame structure, it may be considered whether a backscatter sensing signal received in the sensing symbol affects the non-sensing operation in a next symbol. This affect may be due to the fact that a reception (Rx) backscatter signal has a delayed start compared with a transmission (Tx) sensing signal, with the delay amount depending on a distance to the object, which may affect at least an early portion of next symbol's non-sensing operation. This issue may be addressed by a timing advance at a Uu interface, where a gNB explicitly configures a UE to transmit a sensing signal a certain amount of time in advance, such that the backscatter signal received at the receiver will not interfere with the communication signal in the next symbol. This issue may also be addressed by inserting guard symbols between radar and communication signals.

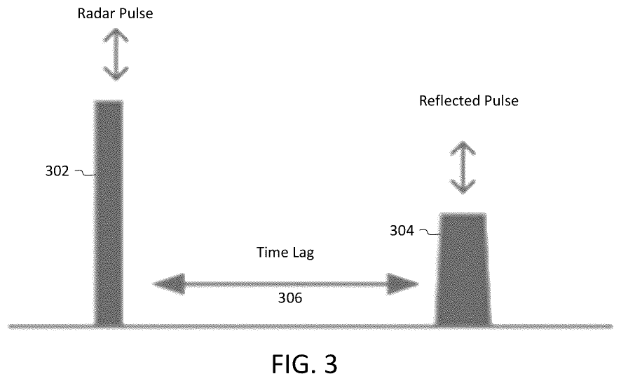

FIG. 3 is a diagram illustrating the coexistence of a sensing signal and a communication signal in a mono-static sensing case, according to an embodiment. Specifically, a UE sends a radar pulse 302 and receives a reflected pulse 304 after a time lag 306 due to round-trip propagation. The reflected pulse 304 may interfere with an uplink data transmission of the UE in a next symbol.

When the time lag 306 is large enough, a guard symbol may be inserted between sensing and communication signals. The guard symbol may be used to complete the reception of the reflected pulse 304 without interfering with the next symbol for communication signals.

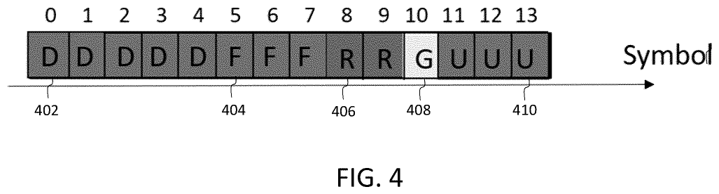

FIG. 4 is a diagram illustrating a slot structure with a combined pattern, according to an embodiment. The combined pattern may be constructed including a defined number of downlink (D) symbols 402 (i.e., symbols 0-4), flexible (F) symbols 404 (i.e., symbols 5-7), radar (R) symbols 406 (i.e., symbols 8, 9), a guard (G) symbol 408 (i.e., symbol 10), and uplink (U) symbols 410 (i.e., symbols 11-13).

According to an embodiment, for mono-static sensing, a subcarrier spacing (SCS) of a sensing signal may be higher than that for communication signals with a shorter symbol duration, such that a UE is able to send a sensing signal in one symbol and receive it in the next symbol.

A time pattern, which is also referred to as a communication-radar slot format, may encompass various structural configurations. This pattern may govern the allocation of slots for radar and communication purposes. The time pattern may include an initial set of slots dedicated to radar operations, followed by a subsequent set of slots designated for communication. Alternatively, the time pattern may involve a combination of slots and symbols for radar, along with another set of slots and symbols for communication. Additionally, the time pattern may incorporate guard symbols or slots, which allow for smooth transitioning between the radar module and the communication module, accounting for any necessary switching time. The resources, symbols, slots, subframes, or frames allocated for radar sensing may further be divided into radar Tx and radar Rx. This division, depending on the UE implementation, may be flexible. For example, time-domain resources may be configured exclusively for radar transmission or radar reception, but not for both simultaneously. Likewise, the resources, symbols, slots, subframes, or frames assigned for communication may be partitioned between D reception, U transmission, and potentially SL communication, among others.

To establish a repetitive sequence, a time pattern may be associated with a periodicity, ensuring that the same pattern repeats after completion of the previous pattern. The network may provide multiple time patterns, and higher layer signaling mechanisms like SIB (e.g., a new SIB or extension or modification of an existing SIB) or RRC (e.g., common/cell-specific RRC or dedicated/UE-specific RRC) messages may be utilized to configure a specific time pattern for the UE.

Alternatively, multiple time patterns may be configured for the UE, allowing for the sequential application of different patterns. For example, the UE may be equipped with two time patterns, each with its own configuration parameters, where the second pattern comes into effect after the conclusion of the first pattern, and vice versa, forming a recurring cycle.

The time pattern or multiple time patterns may be indicated through L1 and L2 signaling methods, such as, for example, MAC CE or DCI. A DCI field or format located within a UE-specific search space (USS) set or a common search space (CSS) set may convey the specific time pattern. Each UE may read its assigned position within the DCI format, which may include a group-common DCI format for multiple UEs.

In summary, the time pattern may encompass diverse configurations dictating the allocation of slots, symbols, and resources for radar and communication purposes. These patterns may be periodically repeated, configured via higher layer signaling, and indicated through L1/L2 signaling mechanisms.

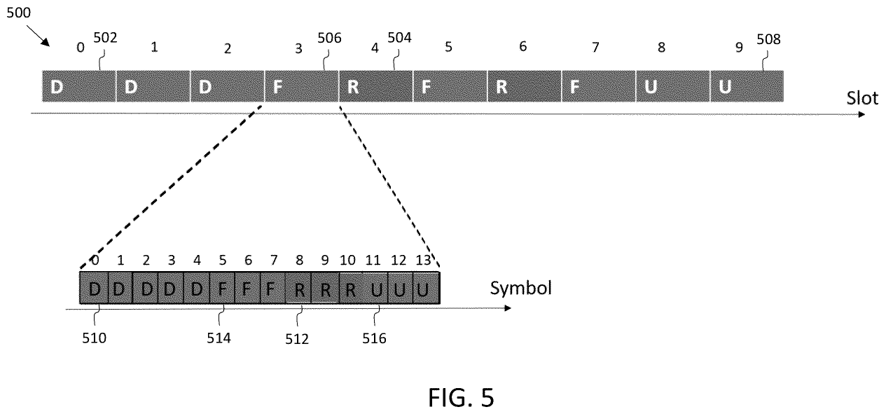

FIG. 5 is a diagram illustrating a time pattern demonstrating the integration of joint communication and sensing, according to an embodiment.

Referring to FIG. 5, the time pattern may allocate specific slots/symbols for DL/UL communications and others for radar sensing. A combined slot pattern (or frame structure) 500 may be constructed that includes a defined number of D slots 502 (i.e., slots 0-2), R slots 504 (i.e., slots 4, 6), F slots 506 (i.e., slots 3, 5, 7), and U slots 508 (i.e., slots 8, 9). Similarly, each F slot 506 may encompass a joint communication and sensing symbol pattern, consisting of a designated number of D symbols 510 (i.e., symbols 0-4), R symbols 512 (i.e., symbols 8-10), F symbols 514 (i.e., symbols 5-7), and U symbols 516 (i.e., symbols 11-13).

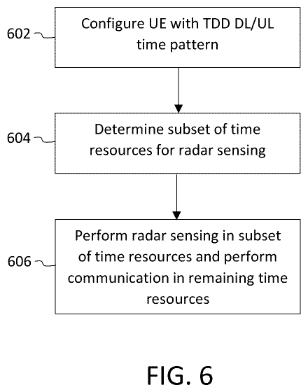

FIG. 6 is a flowchart illustrating a configuration process of a time pattern with allocated resources for communication and sensing, according to an embodiment.

Referring to FIG. 6, at 602, a UE may receive a configuration, from a gNB, defining a first set of time resources for communication. Specifically, the UE may be configured with a TDD DL/UL time pattern. At 604, the UE may receive another configuration, from the gNB, specifying a second set of time resources for radar sensing. For example, the UE may determine a subset of time resources within the TDD UL/DL time pattern for radar sensing. At 606, the UE may carry out communication activities within the first set of resources and radar sensing operations within the second set of resources. For example, the UE performs radar sensing in the subset of time resources within the TDD UL/DL time pattern, and performs communication in remaining resources of the TDD UL/DL time pattern.

According to an embodiment, the numerology utilized for slots and symbols associated with radar sensing transmission and reception may be identical to the numerology used for slots and symbols associated with DL/UL/SL communication. Conversely, these numerologies may differ. The embodiments described herein are not restricted exclusively to OFDM systems as the same concept may be applied to any system that is based on a different waveform technology.

For example, time-domain resources for sensing may be the same as or separate from any measurement gap(s) that is determined/configured for the UE in order to operate outside an active BWP or outside a serving cell, such as for radio resource management (RRM)/radio link monitoring (RLM) measurements from neighbor cell or channel state information (CSI) acquisition outside an active BWP, or for antenna switching or carrier switching, etc.

For example, a UE may be configured with a set of frequency domain resources dedicated to radar sensing. This configuration may specify an absolute frequency location, such as an RB index, to indicate a starting point of frequency resources allocated for radar sensing. Additionally, a value representing the size of this frequency resource set, such as the number of RBs, may be provided. The frequency resources for sensing may be expressed in the same units as those used for communication, or may be expressed in different units. For example, sensing resources may be specified in absolute frequency units (e.g., hertz (Hz), megahertz (MHz), GHz) or in terms of subcarriers (SCs), resource elements (REs), RBs, RBGs, sub-bands, wide-bands, or any other predetermined unit of measurement.

As another example, frequency domain resources allocated for sensing may reside within channel carrier frequency(s) configured as serving cell(s) for communication. These sensing resources may encompass resources from one serving cell or multiple serving cells, including multiple component carriers (CCs) or subsets thereof. These multiple CCs may be intra-band contiguous or non-contiguous CCs, as well as inter-band CCs.

When a UE operates with one or multiple configured BWPs within a serving cell, where one or more BWPs are active, the UE may be configured with sensing frequency resources that fall entirely within the active BWP(s) or partially/entirely outside of them. For example, the UE may be equipped with one or multiple “sensing BWPs,” which can be the same as or distinct from the active DL/UL/SL BWPs. This sensing BWP may be configured by RRC signaling that is similar to existing BWPs of 5G NR. The UE may be designated to perform sensing activities within a dormant BWP. Additionally, in some cases, the frequency domain resources allocated for sensing may be partially or entirely separate from the channel carrier frequency(s) configured as serving cell(s) for communication.

Alternatively, radar sensing and DL/UL/SL communication may utilize overlapping time/frequency resources. Specifically, the resources allocated for radar sensing may partially or completely overlap resources designated for communication. To achieve this, the UE may implement spatial or angular separation between radar sensing transmission and DL/UL/SL communication transmission/reception. This may involve using different beams, spatial filters, or spatial angles for sensing and communication purposes.

For coordination between the sensing and the communication module in the UE, a signaling or information exchange interface may be established to facilitate the selection of distinct beams for communication and sensing. Different implementations may support this exchange. For example, the UE may be equipped with separate antenna panels/arrays for communication transmission (e.g., UL/SL) and radar sensing transmission, allowing for the generation of two different beams simultaneously or within overlapping time resources. Alternatively, the UE may use the same antenna panel/array for both communication and radar sensing, but ensures that their corresponding transmissions occur in non-overlapping time or frequency resources.

According to another embodiment, the UE may have a dedicated antenna array/panel for communication reception (e.g., DL/SL) and a separate antenna array/panel for radar sensing reception. The first or second antenna array/panel may be the same as or different from the antenna panel(s)/array(s) used for communication transmission or radar sensing transmission.

For example, a specific frequency resource and transmitted signal may serve a dual purpose of communication and sensing. A sounding reference signal (SRS)/CSI-SL transmitted by the UE may be detected by the network or neighboring UEs for channel estimation in communication, while the UE may receive the reflected SRS/CSI-SL signal it transmitted for sensing purposes.

To distinguish between sensing and communication transmissions/receptions, the UE may employ (self-)interference cancellation methods. The UE may report its capability of performing self-interference cancellation in advance to the network, such that the network may decide how to multiplex the sensing and communications signal for transmission and reception. For example, the UE may detect a DL/UL/SL channel or signal and may eliminate it to enhance the detection of received sensing waveforms. This interference cancellation may occur in multiple stages, starting with coarse sensing reception/detection, followed by detection and cancellation of communication signals/channels/transport blocks, and concluding with fine sensing detection.

Alternatively, interference cancellation may involve initial detection of communication signals/channels/transport blocks with a higher block error rate (BLER), followed by radar sensing detection and cancellation, and concluding with final detection of communication signals/channels/transport blocks with a lower/target BLER.

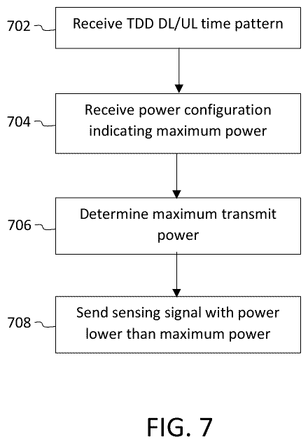

FIG. 7 is a flowchart illustrating a method for performing sensing on uplink slots under certain conditions, according to an embodiment.

At 702, a UE may receive a slot configuration (U, D, F, SL) from a gNB, and may perform sensing on uplink slots (or a subset thereof). Specifically, the UE may receive a TDD DL/UL time pattern from the gNB. Additionally, the UE may be allowed to perform sensing on other slots (e.g., F or SL slots). The set of slots where the UE may perform sensing is signaled by the gNB (e.g., using RRC signaling).

At 704, the UE may receive a power configuration indicating a maximum received power at the gNB that can be tolerated with sensing. The UE ensures that its selected transmitted power is below this maximum received power, which may be signaled using parameters similar to those used for power control (e.g., with a Pcmax value, an alpha coefficient).

At 706, the UE may determine its maximum transmit power Pm. If the parameters for power are signals that are similar those used for power control, the UE may use existing or similar power control equations to determine its power with open-loop power control.

At 708, the UE may send the sensing signal with any power P that is less than or equal to the maximum transmit power Pm on the authorized slot.

According to an embodiment, a UE may transmit a signal to a gNB to request the configuration of time/frequency resources for radar sensing, or to activate/release such configured resources. This signaling may be motivated by the fact that radar sensing may be a UE-side operation with timing determined by the UE's decision or needs, which may be unknown to the gNB. Network-controlled assignment of reference signals for radar sensing may optimize interference impact on the system and neighboring UEs. Coordinating the time/frequency resources for radar sensing may help prevent communication interruptions. For example, the UE may send a signaling or indication to request the gNB to configure a set of resources or activate a set of pre-configured resources for radar sensing. Alternatively, the UE may send a signal or indication to request the gNB to suspend or release a set of pre-configured resources for radar sensing. For example, during the night when sensing may be unnecessary, the UE may request the release of sensing resources, allowing them to be potentially utilized for sensing or communication by other UEs.

The configuration, activation, or release of time/frequency/spatial resources for radar sensing may be triggered by specific conditions, timers, or counters. For example, a UE may request the configuration, activation, or release of sensing resources if it detects a predefined triggering condition. This may occur when the UE senses an object (e.g., finger, face, vehicle) or detects motion (e.g., human gesture, vehicle speeding) with predefined characteristics, such as being within a range threshold, exceeding a velocity threshold, or lasting longer than a threshold duration. These thresholds may be predetermined or pre-configured.

A request for sensing resources may correspond to various settings. For example, a UE's request may pertain to time domain resources for sensing, such as a time/slot pattern for sensing and communication as described above, or a desired periodicity for sensing. Alternatively, the request may involve frequency domain resources, such as a set of RBs or a desired bandwidth for sensing. Additionally, the UE's request may consider sensing performance, complexity, or UE capability, based on configuration parameters, such as a length of a sequence used for radar sensing waveform (e.g., a Zadoff-Chu (ZC) sequence) or the transmission power for a radar sensing waveform/reference signal.

A UE may be configured with different sensing modes, such as coarse sensing and full sensing. In a full sensing mode, the UE may be configured or activated with fine/full sensing resources, including a larger bandwidth and smaller periodicity. Conversely, in a coarse sensing mode, the UE may be configured or activated with coarse sensing resources, such as a smaller bandwidth and larger periodicity. The transition between modes may be triggered by the occurrence of a predefined condition, UE implementation, or gNB decision/signaling. For example, the UE may operate with coarse sensing resources until it detects an object/motion, at which point it can request and receive the configuration/activation of fine sensing resources.

A UE may request the configuration/activation of radar sensing resources based on a target application for sensing. A predefined or pre-configured set of sensing categories may be defined considering various sensing parameters, such as target or maximum sensing range/velocity/elevation/angle/field of view for short-range radar (SRR), mid-range radar (MRR), or long-range radar (LRR). Each category may have corresponding maximum or target values for the specified parameters, minimum resolution/granularity requirements, maximum error tolerances, or maximum transmission/reception power for a sensing waveform or reference signal. Additional parameters related to the definition of sensing categories, such as minimum sensing range/velocity/elevation or maximum resolution for sensing range/velocity, may also be included.

A UE may indicate a request to a gNB for sensing resources by indicating the sensing categories (e.g., using a category index from a set {0,1,2,3} with each category index referring to a corresponding set of sensing parameters as described above and associated with a set of sensing resources).

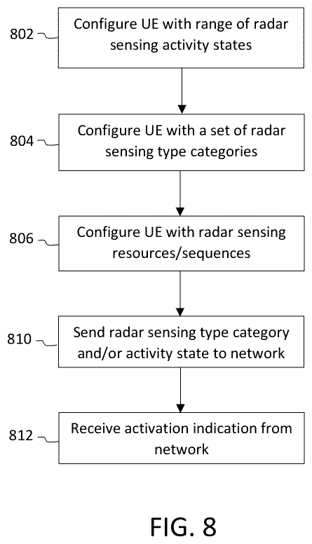

FIG. 8 is a flowchart illustrating a method for requesting and configuring radar sensing resources/sequences, according to an embodiment. This method of FIG. 8 may be facilitated through a systematic connection between radar sensing resources/sequences, radar sensing states, and radar sensing categories.

Referring to FIG. 8, at 802, the UE may be configured, by the gNB, with a range of radar sensing activity states, which encompass full sensing, coarse sensing, and other related states. At 804, the UE is configured, by the gNB, with a set of potential radar sensing type categories, including, for example, target/max sensing range, target/min sensing resolution for location/speed, sensing transmission power, and more.

At 806, the UE may be configured, by the gNB, with radar sensing resources/sequences for one or multiple combinations of radar sensing activity states and radar sensing type categories.

At 808, the UE may send the radar sensing type category and/or activity state to the gNB (or network), which may trigger the initiation of radar sensing operations.

At 810, the UE may receive an activation indication from the gNB (or network), allowing it to perform radar sensing utilizing the resources/sequences associated with the specified radar sensing activity states and/or type categories.

The radar sensing activity states may be linked to various sensing modes, such as full sensing, coarse sensing, and more. Similarly, the radar sensing type categories may be associated with distinct aspects of sensing, such as target/max sensing range, target/min sensing resolution for location/speed, and sensing transmission power.

There are multiple methods for communicating a UE request for configuration/activation/release of time/frequency resources for radar sensing. For example, the request may be treated as a trigger for a random access (RA) procedure that initiates a physical random access channel (PRACH) transmission. This transmission may involve a dedicated (contention-free) PRACH preamble or a contention-based PRACH preamble in a dedicated RACH occasion (RO), among other possibilities. Alternatively, the request may be interpreted as new uplink control information (UCI) or as a modification to an existing UCI type, which can be carried in a physical uplink control channel (PUCCH) resource or multiplexed with a physical uplink shared channel (PUSCH) transmission.

Another option includes indicating the request through specific fields in a DCI format, such as the SRS request field or CSI-RS request field, or through a sidelink CSI-RS request in a sidelink control information (SCI) format. These request fields may be mapped to corresponding radar sensing resources based on predefined or configured linkages. Consequently, the value of the request field may trigger the configuration or transmission/reception of one or multiple SRS/SL CSI-RS/SL SRS resources or resource sets.

In response to the UE's sensing requests, the network may configure and activate the necessary sensing resources to ensure uninterrupted communication for the UE. Network control mechanisms may be employed to prevent significant interference from radar sensing reference signals to the system or neighboring UEs. These mechanisms may include indicating the avoidance of strong interfering beams.

Various interference scenarios may arise in the context of intra-UE and inter-UE interference between radar sensing and communication. In the case of intra-UE interference, a UE's radar sensing receptions may be affected by DL/UL/SL communication transmissions/receptions from the same UE or other UEs. Similarly, a UE's DL/SL communication receptions may experience interference from radar sensing transmissions/receptions from the same UE or other UEs. Moreover, interference may occur in a gNB's reception of a UE's UL communication transmissions due to radar sensing transmissions/receptions from the same UE or other UEs.

Specific instances of inter-UE interference may occur when communication and sensing operations overlap. For example, UL/SL communication by one UE may interfere with the sensing reception of another UE, or the sensing transmission by one UE may interfere with DL/SL communication of another UE. Such inter-UE interference may occur between UEs within the same cell or between UEs in different cells. In another example, inter-UE interference for both communication and sensing may arise when UEs in different cells are involved. Communication transmissions by UEs in one cell may interfere with radar sensing receptions of UEs in a neighboring cell, or radar sensing transmissions by UEs in one cell may interfere with communication receptions of UEs in a neighboring cell. In such cases, UEs may employ techniques including cross-link interference (CLI) or remote interference management (RIM) to mitigate inter-UE interference. These methods may assist in addressing interference issues arising from communication and sensing operations.

To handle intra-UE interference, several methods may be employed for time/frequency/spatial resource configuration or sequence configuration. As described above, these methods ensure that transmissions and receptions within the same UE are orthogonal, thereby avoiding interference. Alternatively, non-orthogonal resource allocation for radar and communication resources may be allowed, with the UE relying on self-interference techniques to distinguish and recover communication signals from sensing signals.

Various approaches exist to address inter-UE interference between radar and communication. In one approach, time/frequency/spatial resources and sequences for radar sensing may be configured in a UE-specific manner. This ensures that different UEs are assigned orthogonal resources, minimizing the risk of interference. For example, the gNB may assign non-overlapping sensing resources to UEs in close proximity (e.g., using graph coloring methods) and reuse these resources for UEs or UE groups located further away, thereby mitigating inter-UE interference.

Another approach involves configuring time/frequency/spatial/sequence parameters for radar sensing in a cell-specific, BWP-specific, or UE-group-specific manner. This provides a shared pool of resources/sequences to be used by multiple UEs operating within a cell, BWP, or a predefined/dynamically indicated group. Proximity and location/ranging of UEs may be used to determine such groups. In such cases, a UE may perform resource sensing for different resources in the shared pool. Once the UE identifies an available resource, it may utilize the corresponding resource/sequence for radar sensing transmission and reception.

Resource sensing may involve UE procedures to provide minimal or no interference from other UEs using the same resource/sequence for radar sensing or communication purposes. The UE determines a resource's availability by checking for any activity by other UEs associated with the resource. Energy detection methods, such as measuring reference signal received power (RSRP), reference signal strength indicator (RSSI), reference signal received quality (RSRQ), signal-to-interference-plus-noise ratio (SINR), and comparing them against thresholds, may be employed for resource sensing. Signal detection methods, including reference signal (RS) detection or payload/transport block (TB) detection, may also be used. In some cases, a combination of both methods may be utilized.

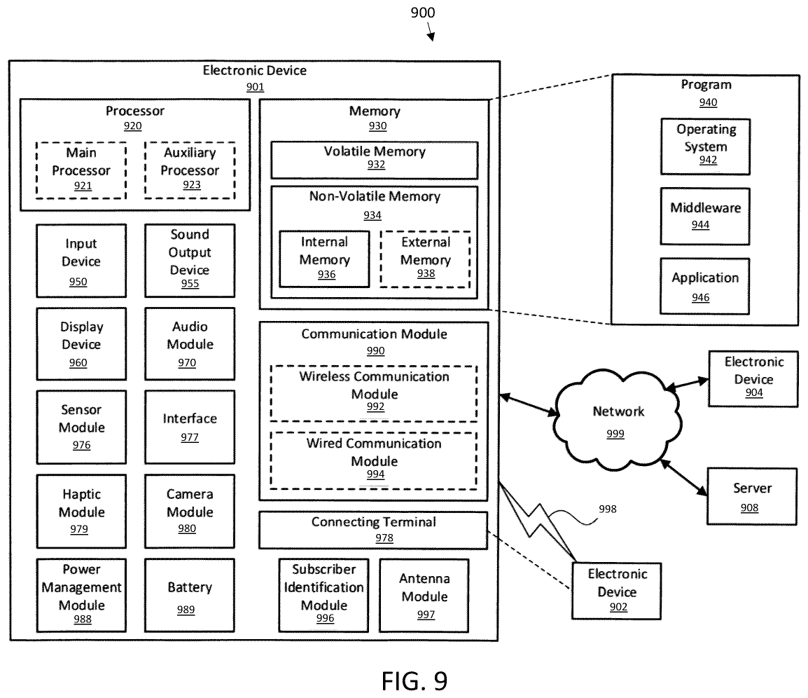

FIG. 9 is a block diagram of an electronic device in a network environment 900, according to an embodiment.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving, by a user equipment (UE) of a wireless system, a first configuration defining a first set of time domain resources for radar sensing, wherein the first configuration comprises at least one of a frame structure comprising radar sensing slots or a slot structure comprising radar sensing symbols; and
performing, by the UE, radar sensing within the first set of time domain resources and first frequency domain resources, wherein the first set of time domain resources at least partially overlap time domain resources for communication based on one or more different beams, spatial filters, or spatial angles, and wherein the first frequency domain resources at least partially overlap second frequency domain resources for communication based on one or more different beams, spatial filters, or spatial angles.

2. The method of claim 1, wherein the first configuration comprises at least one of an absolute frequency location indicating a starting point of the first frequency domain resources and a size of a set of the first frequency domain resources.

3. The method of claim 1, wherein the frame structure comprises downlink slots, flexible slots, the radar sensing slots, and uplink slots.

4. The method of claim 3, wherein at least one of the flexible slots comprises downlink symbols, flexible symbols, radar sensing symbols, and uplink symbols.

5. The method of claim 4, wherein the at least one of the flexible slots comprises a guard symbol between one of the radar sensing symbols and one of the uplink symbols.

6. The method of claim 1, further comprising:
receiving, by the UE, from a gNode B (gNB), a second configuration defining a second set of time domain resources for communication; and
performing, by the UE, communication based on the second configuration,
wherein the first set is within the second set, and communication is performed within remaining time domain resources of the second set, or
wherein the first set is separate from the second set, and communication is performed within the second set.

7. The method of claim 1, further comprising:
transmitting, from the UE, to a gNB, a request for configuration of resources for radar sensing via as a physical random access channel (PRACH)-based transmission, a physical uplink control channel (PUCCH)-based transmission, a physical uplink shared channel (PUSCH)-based transmission, a downlink (DL) downlink control information (DCI)-based transmission, or a sidelink (SL) sidelink control information (SCI)-based transmission.

8. The method of claim 7, further comprising:
configuring the UE with a third set of sensing activity states;
configuring the UE with a fourth set of radar sensing type categories; and
configuring the UE with corresponding radar sensing resources for different combinations of sensing activity states from the third set and radar sensing type categories from the fourth set,
wherein transmitting the request for configuration comprises transmitting an indication of a radar sensing activity state from the third set and a radar sensing type category from the fourth set, and
wherein configuring the UE comprises receiving, by the UE, from the gNB, an activation indication for radar sensing resources associated with the radar sensing activity state and the radar sensing type category.

9. The method of claim 8, wherein the sensing activity states comprise full sensing mode and coarse sensing mode.

10. The method of claim 9, wherein the full sensing mode is configured with resources comprising a larger bandwidth and a smaller periodicity than those of the coarse sensing mode.

11. The method of claim 8, wherein the radar sensing type categories comprise at least one of a sensing range, a sensing velocity, a sensing elevation, a sensing angle, or a sensing field of view for short-range radar (SRR), mid-range radar (MRR), or long-range radar (LRR).

12. The method of claim 8, wherein the UE indicates the radar sensing activity state and the radar sensing type category via an index.

13. A method comprising:
receiving, by a user equipment (UE), a first set of sensing activity states;
receiving, by the UE, a second set of radar sensing type categories;
configuring, by the UE, corresponding radar sensing resources for different combinations of sensing activity states from the first set and radar sensing type categories from the second set;
transmitting, by the UE, to a gNode B (gNB), an indication of a radar sensing activity state from the first set and a radar sensing type category from the second set; and
receiving, by the UE, from the gNB, an activation indication for radar sensing resources associated with the radar sensing activity state and the radar sensing type category.

14. The method of claim 13, wherein the radar sensing activity state and the radar sensing type category are transmitted as a physical random access channel (PRACH)-based transmission, a physical uplink control channel (PUCCH)-based transmission, a physical uplink shared channel (PUSCH)-based transmission, a downlink (DL) downlink control information (DCI)-based transmission, or a sidelink (SL) sidelink control information (SCI)-based transmission.

15. A user equipment (UE) comprising:
a processor; and
a non-transitory computer readable storage medium storing instructions that, when executed, cause the processor to:
receive a first configuration defining a first set of time domain resources for radar sensing, wherein the first configuration comprises at least one of a frame structure comprising radar sensing slots or a slot structure comprising radar sensing symbols; and
perform radar sensing within the first set of time domain resources and first frequency domain resources, wherein the first set of time domain resources at least partially overlap time domain resources for communication based on one or more different beams, spatial filters, or spatial angles, and wherein the first frequency domain resources at least partially overlap second frequency domain resources for communication based on one or more different beams, spatial filters, or spatial angles.

16. The UE of claim 15, wherein the first configuration comprises at least one of an absolute frequency location indicating a starting point of the first frequency domain resources and a size of a set of the first frequency domain resources.

17. The UE of claim 15, wherein:
the frame structure comprises downlink slots, flexible slots, the radar sensing slots, and uplink slots; and
at least one of the flexible slots comprises downlink symbols, flexible symbols, radar sensing symbols, and uplink symbols.

18. The UE of claim 15, wherein the instructions further cause the processor to:
receive, from a gNode B (gNB), a second configuration defining a second set of time domain resources for communication; and
perform communication based on the second configuration,
wherein the first set is within the second set, and communication is performed within remaining time domain resources of the second set, or
wherein the first set is separate from the second set, and communication is performed within the second set.

19. The UE of claim 15, wherein the instructions further cause the processor to transmit, to a gNB, a request for configuration of resources for radar sensing via a physical random access channel (PRACH)-based transmission, a physical uplink control channel (PUCCH)-based transmission, physical uplink shared channel (PUSCH)-based transmission, a downlink (DL) downlink control information (DCI)-based transmission, or a sidelink (SL) sidelink control information (SCI)-based transmission.

20. The UE of claim 15, wherein:
the instructions further cause the processor to:
configure the UE with a third set of sensing activity states;
configure the UE with a fourth set of radar sensing type categories; and
configure the UE with corresponding radar sensing resources for different combinations of sensing activity states from the third set and radar sensing type categories from the fourth set;
in transmitting the request for configuration, the instructions further cause the processor to transmit an indication of a radar sensing activity state from the third set and a radar sensing type category from the fourth set; and
in configurating the UE with the first configuration, the instructions further cause the processor to, receive, from the gNB, an activation indication for radar sensing resources associated with the radar sensing activity state and the radar sensing type category.
